(19) United States
(12) Patent Application Publication
(10) Pub. No.: US 2009/0101864 A1
(43) Pub. Date: Apr. 23, 2009

(54) Chemical Mechanical Polishing Paste for Tantalum Barrier Layer

(76) Inventors: Weihong Peter Song, Shanghai (CN); Guodong Jery Chen, Shanghai (CN); Yuan Gu, Shanghai (CN); Chun Sunny Xu, Shanghai (CN); Ying Michael Song, Shanghai (CN)

Correspondence Address: JACOBSON HOLMAN PLLC, 400 SEVENTH STREET N.W., SUITE 600, WASHINGTON, DC, 20004, US

(21) Appl. No.: 12/084,252

(22) PCT Filed: Oct. 8, 2006
(86) PCT No.: PCT/CN2006/002620

§ 371 Date: Apr. 28, 2008

(30) Foreign Application Priority Data
Oct. 28, 2005 (CN) 200510030869.1

(51) Int. Cl. C09K 13/00

(52) U.S. Cl. 252/79.1

(57) ABSTRACT

A chemical mechanical polishing slurry for Ta barrier layer is disclosed, which comprises abrasive particles A, abrasive particles B larger in size than abrasive particles A, a triazole compound, an organic acid and a carrier. By using the chemical mechanical polishing slurry according to the present invention, the defects, scratches, contaminants and other residues can be reduced significantly, and the polishing selectivity between the barrier layer and the oxide layer can be adjusted by using particles of different sizes, so that the difficulty of adjusting the removing rates of two substrates separately is overcome. Furthermore, both the local corrosion and the general corrosion during the metal polishing process are avoided, and thus the yield rate of the desired products is promoted.

### TECHNICAL FIELD

The present invention relates to a chemical mechanical polishing slurry, in particular, to a chemical mechanical polishing slurry for a tantalum barrier layer.

### BACKGROUND ART

With the development of microelectronic technologies, an ultra large scale integrated circuit microchip may have a characteristic size on the scale of nanometers and integrate several billions of elements and devices. Therefore, chemical mechanical planarization must be carried out in hundreds of procedures in a microelectronic process, particularly for multi-wiring, substrates and media. Conventional aluminum based ultra large scale integrated wiring is giving its place to copper based wiring, for the latter exhibits lower electric resistivity, higher anti-electromigration, shorter RC delay, half less wiring layers, 30% less cost, and 40% less processing time. Owing to these virtues, copper wiring has attracted worldwide interest.

In order to keep the characteristics of copper wiring and media, Ta or TaN is used as the barrier layer for multi-layer copper wiring in an ultra large scale integrated circuit according to the prior art. Thus, chemical mechanical polishing (CMP) slurries used for polishing Ta or TaN barrier layers respectively are formed. Taken as examples, U.S. Pat. No. 6,719,920 disclosed a polishing slurry used for a barrier layer; U.S. Pat. No. 6,503,418 disclosed a polishing slurry for a Ta barrier layer, which comprised organic additives; U.S. Pat. No. 6,638,326 disclosed a chemical mechanical planarization composition used for Ta and TaN; and CN 02116761.3 disclosed a global chemical mechanical planarization slurry for copper and tantalum in multi-layer copper wiring of very large scale integrated circuits. However, these slurries suffered from some drawbacks, including local and general corrosion, high deficiency, rather unreasonable polishing selectivity between Ta barrier layer and an oxide layer, and the difficulty of adjusting separately the removing rates of the two substrates. Therefore, there is an urgent need to develop a new chemical mechanical polishing slurry for a Ta barrier layer.

### SUMMARY OF INVENTION

The object of the present invention is to provide a chemical mechanical polishing slurry for a Ta barrier layer, so as to adjust the polishing selectivity between the Ta barrier layer and an oxide layer, and adjust the removing rate of copper.

The foregoing object according to the present invention may be achieved by means of the following technical solution: the chemical mechanical polishing slurry for the Ta barrier layer comprises abrasive particles A, abrasive particles B larger in size than abrasive particles A, a triazole compound, an organic acid and a carrier. The chemical mechanical polishing slurry is characterized by that it can adjust the polishing selectivity between the Ta barrier layer and the oxide layer by using abrasive particles of different sizes, and change the removing rate of copper by using an organic acid and a triazole compound, so as to prevent the formation of dishings on the metal, and significantly reduce organic substances, silica deposits and metallic ions left on the wafer.

In a preferred embodiment according to the present invention, the size of the abrasive particles A is in the range of 15-50 nm, preferably in the range of 30-50 nm; and the size of the abrasive particles B is in the range of 60-100 nm, preferably in the range of 60-80 nm.

While the chemical mechanical polishing slurry for the Ta barrier layer according to the present invention may incorporate the various components in accordance with the prior art, it is preferred that, based on the total weight of the chemical mechanical polishing slurry, the concentration of the abrasive particles A is in the range of 0.1-5%, preferably in the range of 0.2-1%; the concentration of the abrasive particles B is in the range of 0.1-5%, preferably in the range of 1-5%; the concentration of the triazole compound is in the range of 0.01-1%; the concentration of the organic acid is in the range of 0.01-0.5%; and the carrier makes up for the balance. The slurry according to the present invention may achieve a suitable polishing rate and selectivity at a lower concentration of abrasive particles, allowing a notable alleviation of surface contamination and metallic corrosion.

In order to further improve the polishing performance of the substrate, the chemical mechanical polishing slurry according to the present invention preferably comprises an oxide having a content ranging from 0.001% to 5%, which may be selected from the various oxides in the prior art, preferably selected from hydroperoxide, peracetic acid, benzoyl peroxide, potassium persulfate and/or ammonium persulfate, more preferably hydroperoxide.

The abrasive particles A according to the present invention may be selected from the various abrasive particles in the prior art, preferably selected from silicon oxide, aluminum oxide, cerium oxide and/or polymeric particles (such as polyethylene and polytetrafluoroethylene), more preferably silicon oxide. The abrasive particles B may also be selected from various abrasive particles, preferably selected from silicon oxide, aluminum oxide, cerium oxide and/or polymeric particles, more preferably silicon oxide.

The organic acid mentioned above may be selected from various organic acids, preferably selected from oxalic acid, propane diacid, butane diacid, citric acid, malic acid, amino acids and/or organic phosphonic acids, preferably organic phosphonic acids, more preferably 2-phosphonobutane 1,2,4-tricarboxylic acid.

The triazole compound mentioned above may be selected from various triazole compounds, including benzotriazole (BTA) and/or methyl benzotriazole, preferably benzotriazole.

In a preferred embodiment according to the present invention, the chemical mechanical polishing slurry has a pH in the range of 2.0-4.0, preferably 3.0. Potassium hydroxide, nitric acid, ethanolamine and/or triethanolamine and the like may be used as the pH adjuster.

In the present invention, water is preferably used as the carrier mentioned above.

The chemical mechanical polishing slurry according to the present invention may further comprise other additives, such as surfactants, complexing agents, inhibitors, passivators and/or film formers and the like, which may be used according to the prior art.

The beneficial effects according to the present invention lie in that abrasive particles of different sizes are used in the chemical mechanical polishing slurry according to the present invention to adjust the polishing selectivity between the Ta barrier layer and the oxide layer, so that the difficulty of adjusting separately the removing rates of two substrates has been overcome, even in the case that the concentration of the abrasive particles is relatively low, and that the defects, scratches, contaminants and other residues are reduced significantly. Furthermore, the chemical mechanical polishing slurry according to the present invention can be used without incurring local or general corrosion during the metal polishing process, thus promoting the yield rate of the desired products.

### BRIEF DESCRIPTION OF THE DRAWINGS

FIG. 1 shows the microgram of the surface of a blank tantalum wafer before being polished.

FIG. 2 shows the microgram of the surface of a blank tantalum wafer after being polished.

FIG. 3 shows the microgram of the surface of a testing wafer after being polished (wherein TEOS represents SiO₂).

FIG. 4 shows the microgram of the surface of a copper wire in a testing wafer after being polished.

FIG. 5 shows the sectional view of a testing wafer before being polished.

FIG. 6 shows the sectional view of a testing wafer after being polished.

### BEST MODE FOR CARRYING OUT THE INVENTION

Examples 1-8 and Comparative Examples 1° and 2°

TABLE 1

| | Abrasive Particles A | | | Abrasive Particles B | | | Organic Acid | | | | |
|---|---|---|---|---|---|---|---|---|---|---|---|
| | | Con. | Size | | Con. | Size | | Con. | H₂O₂ | BTA | |
| Ex. | Class | (wt %) | (nm) | Class | (wt %) | (nm) | Class | (wt %) | (wt %) | (wt %) | pH |
| 1° | SiO₂ | 2 | 35 | | | | PBTCA | 0.1 | 0.05 | 0.1 | 3.0 |
| 2° | | | | SiO₂ | 2 | 70 | PBTCA | 0.1 | 0.05 | 0.1 | 3.0 |
| 1 | SiO₂ | 1.5 | 35 | SiO₂ | 1.5 | 70 | PBTCA | 0.1 | 0.05 | 0.1 | 3.0 |
| 2 | SiO₂ | 1 | 35 | SiO₂ | 2 | 70 | PBTCA | 0.1 | 0.05 | 0.1 | 3.0 |
| 3 | SiO₂ | 2 | 35 | SiO₂ | 1 | 70 | PBTCA | 0.1 | 0.05 | 0.1 | 3.0 |
| 4 | SiO₂ | 1.5 | 35 | SiO₂ | 1.5 | 70 | PBTCA | 0.1 | 0.5 | 0.1 | 3.0 |
| 5 | SiO₂ | 0.2 | 35 | SiO₂ | 3 | 70 | PBTCA | 0.1 | 0.05 | 0.1 | 3.0 |
| 6 | SiO₂ | 3 | 35 | SiO₂ | 0.2 | 70 | PBTCA | 0.1 | 0.05 | 0.1 | 3.0 |
| 7 | CeO₂ | 5 | 15 | Al₂O₃ | 5 | 60 | oxalic | 0.5 | | 0.01 | 4.0 |
| | | | | | | | acid | | | | |
| 8 | Al₂O₃ | 0.1 | 50 | CeO₂ | 0.1 | 100 | lysine | 0.01 | | 1 | 2.0 |

Note: PBTCA represents 2-phosphonobutane 1,2,4-tricarboxylic acid. The component that is not shown in the table for each of the chemical mechanical polishing slurry is water. 1° and 2° represent Example 1° and Example 2° respectively.

Abrasive particles A, abrasive particles B, half the available deionized water, the organic acid, BTA and H₂O₂ were charged in sequence into a reactor and the mixture was stirred homogeneously. The rest of the available deionized water was added, and then pH was adjusted to the desired value using a pH adjuster (20% KOH or dilute HNO₃, depending on the desired pH). Stirring was continued till a homogenous fluid was produced. After kept static for 10 minutes, a chemical mechanical polishing slurry was obtained.

### Effect Example 1

The chemical mechanical polishing slurries as described in Examples 1°, 2° and Examples 1-8 were used to polish blank Ta, Cu and SiO₂ wafers respectively under the same polishing conditions as follows: Logitech polishing pad; downward pressure=2 psi; rotating speed of the polishing plate/rotating speed of the polishing head=60/80 rpm; polishing time=120 s; flow rate of the polishing slurry=100 mL/min. The results are shown in Table 2.

TABLE 2

| | Ta | | Cu | | SiO₂ | |
|---|---|---|---|---|---|---|
| | Polishing | | Polishing | | Polishing | |
| | rate | | rate | | rate | |
| CMP Slurry | (Å/min) | Surf | (Å/min) | Surf | (Å/min) | Surf |
| Comparative | 410 | No | 71 | Little | 52 | Little |
| Example 1° | | | | | | |
| Comparative | 275 | No | 114 | Little | 265 | Little |
| Example 2° | | | | | | |
| Example 1 | 383 | No | 66 | No | 344 | No |
| Example 2 | 362 | No | 96 | No | 307 | No |
| Example 3 | 389 | No | 52 | No | 361 | No |
| Example 4 | 425 | No | 432 | No | 398 | No |
| Example 5 | 405 | No | 155 | No | 540 | No |
| Example 6 | 485 | No | 143 | No | 185 | No |
| Example 7 | 515 | Little | 186 | Yes | 850 | Little |
| Example 8 | 142 | Little | 64 | Little | 116 | Little |

Note:
Surf shows the contamination on the substrate surface.

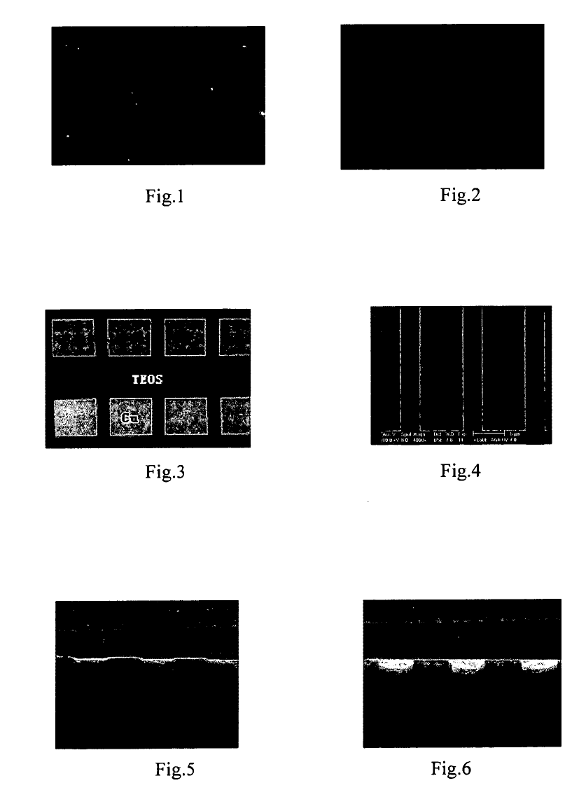

The results indicate that the chemical mechanical polishing slurry according to the present invention can effectively adjust the polishing selectivity between the barrier layer and the oxide layer, so that the difficulty of adjusting separately the removing rates of two substrates can be overcome even in the case that the concentration of the abrasive particles is relatively low; and that few or no contaminants are left on the polished wafer surface. The micrograms of the blank Ta wafers before and after being polished are shown in FIGS. 1 and 2 (wherein FIG. 2 shows the microgram of the surface of the blank Ta wafer after being polished with the chemical mechanical polishing slurry according to Example 1), from which it can be seen that pitting corrosion occurred on the surface of the blank Ta wafer before being polished, but it disappeared after the surface was polished.

### Effect Example 2

Silicon dioxide testing wafers, which had been sputtered with Ta and electroplated with copper, were subjected to copper polishing, and then were polished using the chemical mechanical polishing slurries as described in Examples 2°, 1 and 3 respectively under the same polishing conditions as follows: Logitech polishing pad; downward pressure=2 psi; rotating speed of the polishing plate/rotating speed of the polishing head=60/80 rpm; polishing time=120 s; flow rate of the polishing slurry=100 mL/min. The results are shown in Table 3.

TABLE 3
Conditions of Testing Wafer Surfaces

| | Dishing Size on Wafer | Contamination |
|---|---|---|
| | Surface | on Wafer |
| CMP Slurry | (Å) | Surface |
| Comparative Example 2° | 650 | No |
| Example 1 | 550 | No |
| Example 3 | 484 | No |

The results indicate that, compared with the chemical mechanical polishing slurry according to Comparative Example 2° which didn't contain abrasive particles of two different sizes, the chemical mechanical polishing slurries according to the present invention can significantly reduce the dishing sizes on the surface of the testing wafers, more specifically, from 650 Å to 484 Å; and the surfaces of the testing wafers were not contaminated. FIGS. 3 and 4 show the surfaces of the testing wafers after being polished with the chemical mechanical polishing slurry according to Example 1, FIG. 5 shows the sectional view of the testing wafer before being polished, and FIG. 6 shows the sectional view of the testing wafer after being polished with the chemical mechanical polishing slurry according to Example 3, from which it can be seen that the surfaces of the polished testing wafers exhibit neither noticeable defects nor notable dishings, and that the copper wires are in good order.

### CONCLUSIONS

Due to the fact that abrasive particles of different sizes are used in the chemical mechanical polishing slurry according to the present invention, the polishing selectivity between Ta barrier layer and an oxide layer can be adjusted, so that the difficulty of adjusting separately the removing rates of two substrates has been overcome, even in the case that the concentration of the abrasive particles is relatively low, and thus the defects, scratches, contaminants and other residues are reduced significantly. Furthermore, the chemical mechanical polishing slurry according to the present invention can be used without incurring local or general corrosion during the metal polishing process, thus promoting the yield rate of the desired products.

All the starting materials used in the above examples are available from market.

1: A chemical mechanical polishing slurry for Ta barrier layer, comprising abrasive particles A, abrasive particles B larger in size than abrasive particles A, a triazole compound, an organic acid and a carrier, wherein the chemical mechanical polishing slurry has a pH in the range of 2.0-4.0.

2: The chemical mechanical polishing slurry of claim 1, wherein the abrasive particles A have a size in the range of 15-50 nm, and the abrasive particles B have a size in the range of 60-100 nm.

3: The chemical mechanical polishing slurry of claim 2, wherein the abrasive particles A have a size in the range of 30-50 nm, and the abrasive particles B have a size in the range of 60-80 nm.

4: The chemical mechanical polishing slurry of claim 1, wherein the concentration of the abrasive particles A is in the range of 0.1-5%; the concentration of the abrasive particles B is in the range of 0.1-5%; the concentration of the triazole compound is in the range of 0.01-1%; the concentration of the organic acid is in the range of 0.01-0.5%; and the carrier makes up for the balance.

5: The chemical mechanical polishing slurry of claim 4, wherein the concentration of the abrasive particles A is in the range of 0.2-1%; the concentration of the abrasive particles B is in the range of 1-5%.

6: The chemical mechanical polishing slurry of claim 4, wherein it further comprises an oxide having a content ranging from 0.001% to 5%.

7: The chemical mechanical polishing slurry of claim 6, wherein the oxide is selected from hydroperoxide, peracetic acid, benzoyl peroxide, potassium persulfate and/or ammonium persulfate.

8: The chemical mechanical polishing slurry of claim 1, wherein the abrasive particles A are selected from silicon oxide, aluminum oxide, cerium oxide and/or polymeric particles, and the abrasive particles B are selected from silicon oxide, aluminum oxide, cerium oxide and/or polymeric particles.

9: The chemical mechanical polishing slurry of claim 8, wherein the abrasive particles A and the abrasive particles B are of the same class of particles.

10: The chemical mechanical polishing slurry of claim 9, wherein the abrasive particles A and the abrasive particles B are both silicon oxide particles.

11: The chemical mechanical polishing slurry of claim 1, wherein the organic acid is selected from oxalic acid, propane diacid, butane diacid, citric acid, malic acid, amino acids and/or organic phosphonic acids.

12: The chemical mechanical polishing slurry of claim 11, wherein the organic acid is organic phosphonic acids.

13: The chemical mechanical polishing slurry of claim 12, wherein the organic acid is 2-phosphonobutane 1,2,4-tricarboxylic acid.

14: The chemical mechanical polishing slurry of claim 1, wherein the triazole acid is benzotriazole and/or methyl benzotriazole.
